(19) United States
(12) Patent Application Publication
(10) Pub. No.: US 2025/0340326 A1
(43) Pub. Date: Nov. 6, 2025

(54) Drink-Enhancer System

(71) Applicant: Dyla LLC, Edison, NJ (US)

(72) Inventors: Joel Nunez, Edison, NJ (US); Neel Premkumar, Edison, NJ (US); Dan Pelligra, Edison, NJ (US); Justin Lawrence, Edison, NJ (US)

(21) Appl. No.: 18/920,693

(22) Filed: Oct. 18, 2024

Related U.S. Application Data
(60) Provisional application No. 63/642,090, filed on May 3, 2024.

(51) Int. Cl. B65D 8/00; A23L 2/56

(52) U.S. Cl. CPC B65D 11/04; A23L 2/56

(57) ABSTRACT

A drink-enhancer system comprising a container apparatus and a plurality of drink-enhancers. The container apparatus comprises a first chamber, a second chamber, and a barrier to prevent liquid within one of the first and second chambers to flow to the other of the first and second chambers. The plurality of drink-enhancers comprise at least a first drink-enhancers and a second drink-enhancers. Each of the first and second drink-enhancers are liquid. The second drink-enhancer is different from the first drink-enhancer. The first drink enhancer is in the first chamber of the container apparatus. The second drink enhancer is within the second chamber of the container apparatus. The contents of the first chamber is different from the contents of the second chamber.

### CROSS-REFERENCE TO RELATED APPLICATIONS

This application claims the benefit of U.S. Provisional Application No. 63/642,090, filed May 3, 2024, the entirety of which is hereby incorporated by reference.

### STATEMENT REGARDING FEDERALLY SPONSORED RESEARCH OR DEVELOPMENT

Not Applicable.

### APPENDIX

Not Applicable.

### BACKGROUND OF THE INVENTION

### Field of the Invention

This invention pertains to a drink-enhancer system.

### SUMMARY

One aspect of the disclosure is a drink-enhancer system comprising a container apparatus and a plurality of drink enhancers. The container apparatus comprises a first chamber, a second chamber, and a barrier to prevent liquid within one of the first and second chambers to flow to the other of the first and second chambers. The plurality of drink-enhancers comprise at least a first drink-enhancer and a second drink-enhancer. Each of the first and second drink-enhancers are liquid. The second drink-enhancer is different from the first drink-enhancer. The first drink-enhancer is in the first chamber of the container apparatus. The second drink- enhancer is within the second chamber of the container apparatus. The contents of the first chamber are different from the contents of the second chamber.

Further features and advantages, as well as the operation, are described in detail below with reference to the accompanying drawings.

### BRIEF DESCRIPTION OF THE DRAWINGS

FIG. 1 is a perspective view of an embodiment of a drink-enhancer system.

FIG. 2 is a front view of the drink-enhancer system of FIG. 1.

FIG. 3 is a cross-section view of the embodiment of a drink-enhancer system of FIG. 1.

FIG. 4 is a perspective view of another embodiment of a drink-enhancer system.

FIG. 5 is a perspective view of the drink-enhancer system of FIG. 4 with an alternative style of closure.

FIG. 6 is a perspective view of the drink-enhancer system of FIG. 4 with the closure removed.

FIG. 7 is a cross-section view of the embodiment of a drink-enhancer system of FIG. 4.

FIG. 8 is yet another embodiment of a drink-enhancer system.

FIG. 9 is yet another embodiment of a drink-enhancer system.

FIG. 10 is a perspective view of the drink-enhancer system of FIG. 9 with a closure in the open position.

FIG. 11 is a perspective view of the drink-enhancer system of FIG. 9 with shrink wrap applied.

FIG. 12 is a magnified view of a portion of the drink-enhancer system of FIG. 11.

FIG. 13 is a perspective view of the drink-enhancer system of FIG. 11 with a portion of the shrink wrap removed.

FIG. 14 is a flow diagram for a method of using the drink-enhancer system of FIG. 9.

Reference numerals in the written specification and in the figures indicate corresponding items.

### DETAILED DESCRIPTION

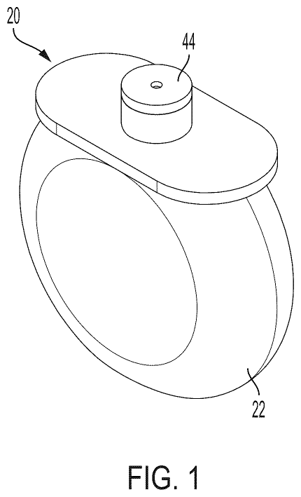

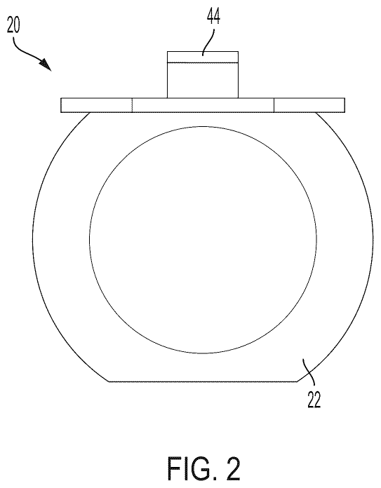

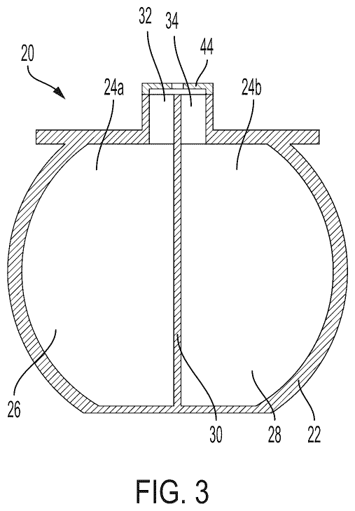

Referring to FIGS. 1-3, an embodiment of a drink-enhancer system in accordance with the present disclosure is indicated generally by reference number 20. The drink-enhancer system 20 comprises a container apparatus 22 and a plurality of drink-enhancers 24.

The container apparatus 22 comprises a first chamber 26, a second chamber 28, and a barrier 30 to prevent liquid within one of the first and second chambers to flow to the other of the first and second chambers. The container apparatus 22 may be a unitary, one-piece, molded member (e.g., injection molded, blow molded, roto-molded). Alternatively, the container apparatus 22 may comprise a first member 22a and a second member 22b. The first member 22a may constitute a first container 22a and the second member 22b may constitute a second container 22b. The first member may be a unitary, one-piece molded member, and the second member may be unitary, one-piece molded member. The first chamber may be within and defined by the first member, and the second chamber may be within and defined by the second member. The first member may be fixedly secured to the second member. The container apparatus 22 may also be constructed by non-molding techniques such as 3D-printing (e.g., stereolithography, selective laser sintering, fused deposition modeling, hindered asynchronous light synthesis, and the like).

The plurality of drink-enhancers 24 comprise at least a first drink-enhancer 24a and a second drink-enhancer 24b. Each of the first and second drink-enhancers 24a, 24b are liquid. The second drink-enhancer 24b is different from the first drink-enhancer 24a. The first drink-enhancer 24a is within the first chamber 26 of the container apparatus 22. The second drink-enhancer 24b is within the second chamber 28 of the container apparatus 22. The contents of the first chamber 26 are different from the contents of the second chamber 28.

The drink-enhancer system may further comprise a first discharge opening 32 and a second discharge opening 34. The first discharge opening 32 is adapted and configured to discharge the first drink-enhancer 24a from the first chamber 26. The second discharge opening 34 is adapted and configured to discharge the second drink-enhancer 24b from the second chamber 28. The container apparatus 22 may further comprise at least one closure 36 for the first and second discharge openings 32, 34. The at least one closure 36 may be adapted and configured to removably cover both the first and second discharge openings 32, 34.

As shown in FIGS. 1-3, the drink-enhancer system may further comprise an outlet valve 44. Each of the first and second chambers 26, 28 may be in fluid communication with the outlet valve 44 such that the first and second drink-enhancers 24a, 24b may flow from the first and second chambers and be discharged from the outlet valve.

The outlet valve 44 of the drink-enhancer system may further comprise a flow-control valve, such as those commercially available from Aptar®. The outlet valve 44 may be in fluid communication with both the first and second chamber simultaneously. The flow-control valve may be adapted and configured to dispense a specific dosage of the first and/or second drink-enhancers 24a,b.

The first drink-enhancer 24a may comprise one or more of: a flavor component, one or more alcohol based solvent compounds, one or more acids, a fruit juice concentrate, a caffeine, electrolyte, vitamin, mineral, probiotic, prebiotic, protein, fatty acid, fiber, carbohydrate, oil, grain, amino acid, juice concentrate, fruit extract, vegetable extract, herbal extract, phytochemical, antioxidant, or superfood.

Likewise, the second drink-enhancer 24b may comprise one or more of: a flavor component, one or more alcohol based solvent compounds, one or more acids, a fruit juice concentrate, a caffeine, electrolyte, vitamin, mineral, probiotic, prebiotic, protein, fatty acid, fiber, carbohydrate, oil, grain, amino acid, juice concentrate, fruit extract, vegetable extract, herbal extract, phytochemical, antioxidant, or superfood.

For example, the first drink-enhancer 24a may comprise at least an acid and the second drink-enhancer 24b may comprise at least a sweetener (e.g., sucralose, aspartame, acesulfame potassium, stevia, monk fruit, and the like).

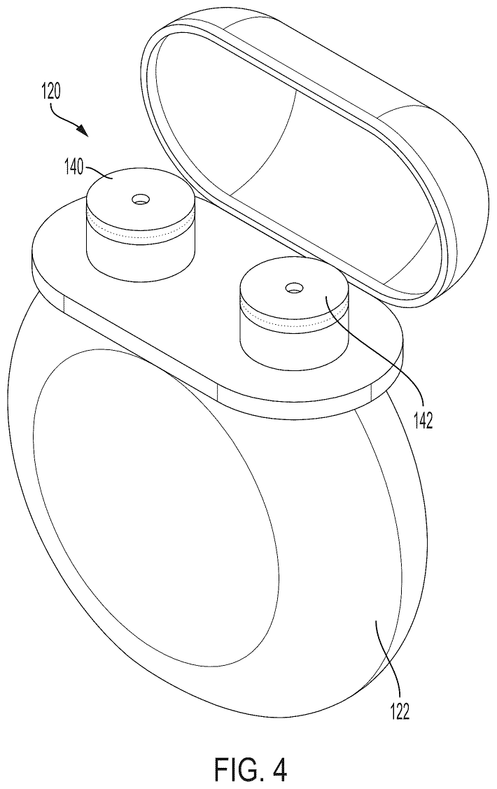

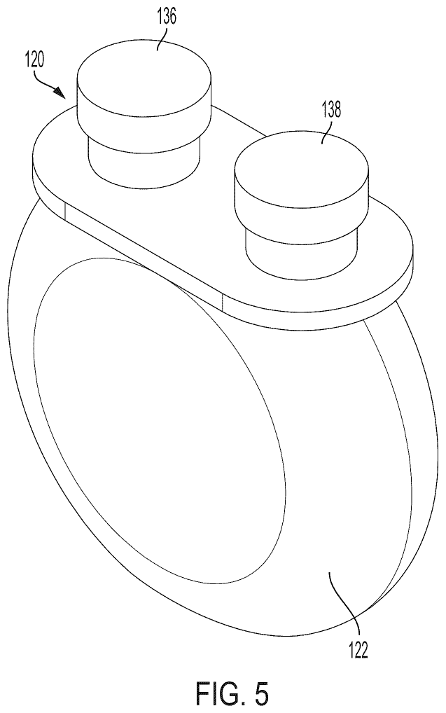

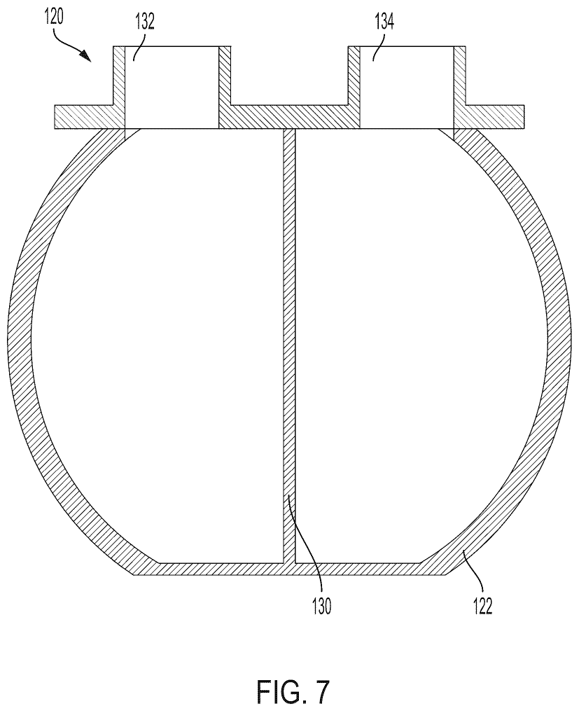

Another embodiment of a drink-enhancer system, indicated generally at 120, is shown in FIGS. 4-7. The above description of the drink-enhancer system 20 of FIGS. 1-3 applies equally to the drink-enhancer system 120, except for the differences noted in the description of the embodiment of FIGS. 4-7. It is also to be understood that components, elements, features, or regions of the embodiment of FIGS. 4-7 have reference numbers corresponding to the reference numbers of the embodiment of FIGS. 1-3, except the reference numbers of the embodiment of FIGS. 4-7 include a prefix “1.” The drink-enhancer system 120 of FIGS. 4-7 is similar to the drink-enhancer system 20 of FIGS. 1-3, except the drink-enhancer system 120 comprises a first closure 136 and a second closure 138. The first closure 136 is adapted and configured to removably cover the first discharge opening 132. The second closure 138 is adapted and configured to removably cover the second discharge opening 134. The first closure 136 and the second closure 138 are independently operable.

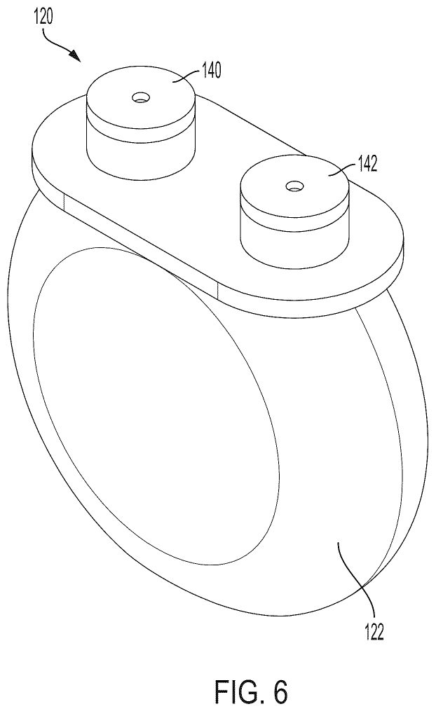

As shown in FIGS. 4 and 6, the drink-enhancer system 120 may further comprise a first outlet valve 140 in fluid communication with the first discharge opening 132, and a second outlet valve 142 in fluid communication with the second discharge opening 134. Each of the first and second valves 140, 142 is movable between a closed position and an open position. Each of the first and second valves 140, 142 are biased towards the closed position. The first valve 140 is movable from its closed position to its open position upon an increase of fluid pressure in the first chamber 126. The second valve 142 is movable from its closed position to its open position upon an increase of fluid pressure in the second chamber 128.

The first and second outlet valves 140, 142 of the drink-enhancer system may further comprise a flow-control valve, such as those commercially available from Aptar®. The first outlet valve 140 may be in fluid communication with the first chamber 126, and the second outlet valve 142 may be in fluid communication with the second chamber 128. The flow-control valve may be adapted and configured to dispense a specific dosage of the first and/or second drink-enhancers 124a,b.

At least the first drink-enhancer may be added to a drink (not shown). The drink may comprise one or more of water, sparkling water, ice, dairy milk, plant-based milk, hard liquor, beer, wine, carbonated beverage, fermented beverage, sports drink, energy drink, juice, tea, and coffee. Likewise, at least the second drink-enhancer may be added to a drink (not shown). The drink may comprise one or more of water, sparkling water, ice, dairy milk, plant-based milk, hard liquor, beer, wine, carbonated beverage, fermented beverage, sports drink, energy drink, juice, tea, and coffee.

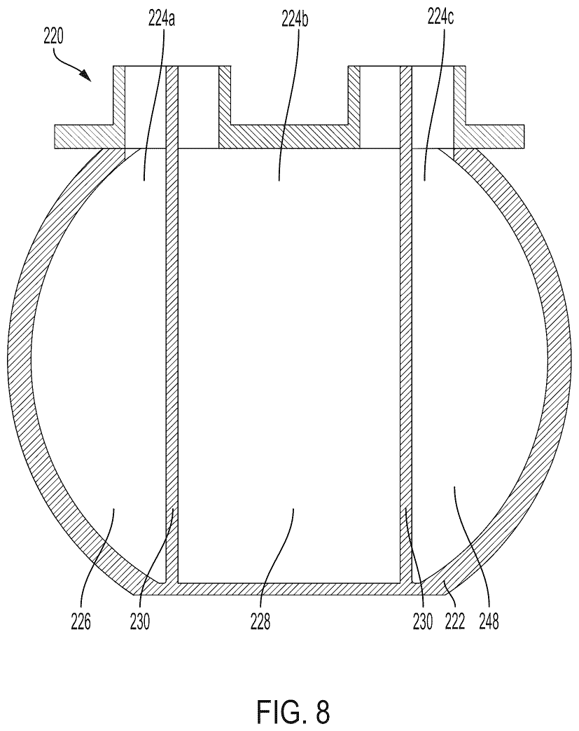

Another embodiment of a drink-enhancer system, indicated generally at 220, is shown in FIG. 8. The above description of the drink-enhancer systems 20 and 120 of FIGS. 1-3 and 4-7, respectively, applies equally to the drink-enhancer system 220, except for the differences noted in the description of the embodiment of FIG. 8. It is also to be understood that components, elements, features, or regions of the embodiment of FIG. 8 have reference numbers corresponding to the reference numbers of the embodiment of FIGS. 1-3 and/or 4-7, except the reference numbers of the embodiment of FIG. 8 includes a prefix “2.”

The drink-enhancer system 220 further comprises a third-chamber 248 and a third-drink enhancer 224c. The third drink-enhancer 224c is different from the first and second drink enhancers 224a, 224b. The third drink-enhancer 224c is within the third chamber 248 of the container 222. The barrier 230 prevents liquid within the first, second, or third chambers 226, 228, 248 from flowing to any of the other chambers.

The third drink-enhancer 224c may comprise one or more of: a flavor component, one or more alcohol based solvent compounds, one or more acids, a fruit juice concentrate, a caffeine, electrolyte, vitamin, mineral, probiotic, prebiotic, protein, fatty acid, fiber, carbohydrate, oil, grain, amino acid, juice concentrate, fruit extract, vegetable extract, herbal extract, phytochemical, antioxidant, or superfood.

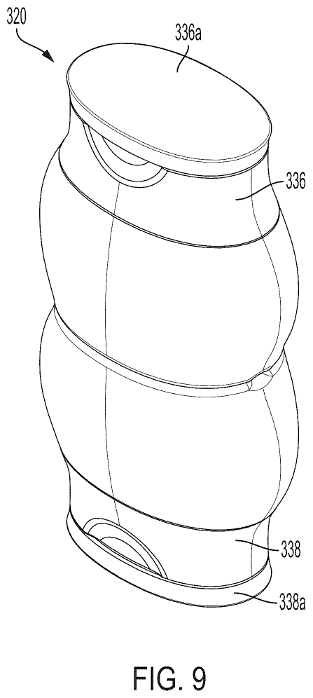

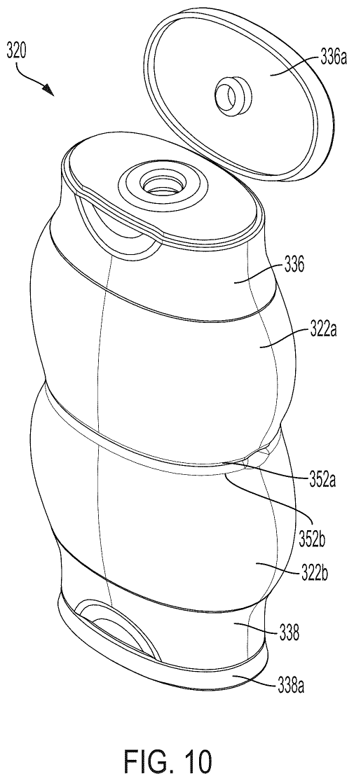

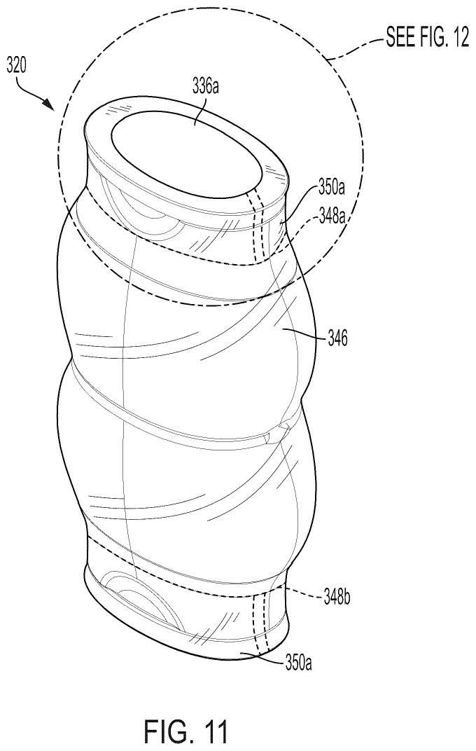

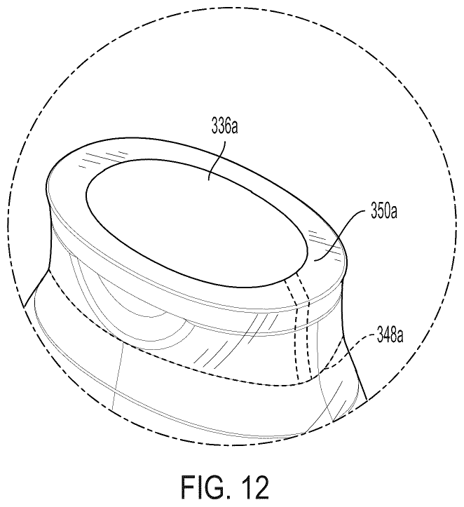

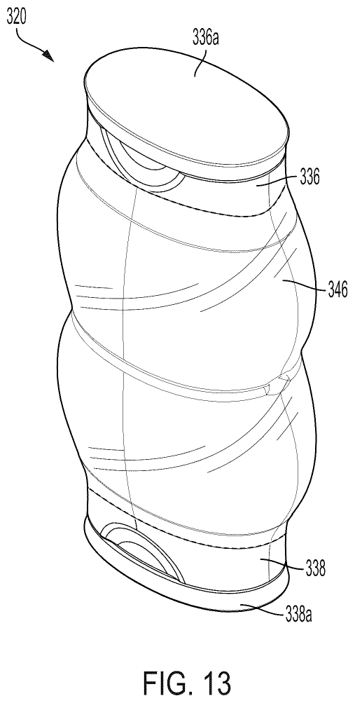

Another embodiment of a drink-enhancer system, indicated generally at 320, is shown in FIGS. 9-13. The above description of the drink-enhancer system 20 of FIGS. 1-3, 120 of FIGS. 4-7, and 220 of FIG. 8 applies equally to the drink-enhancer system 320, except for the differences noted in the description of the embodiment of FIGS. 9-13. It is also to be understood that components, elements, features, or regions of the embodiment of FIGS. 9-13 have reference numbers corresponding to the reference numbers of the embodiments of FIGS. 1-3, 4-7, and 8 except the reference numbers of the embodiment of FIGS. 9-13 include a prefix “3.”

The first member 322a may comprise a first bottle 322a and the second member 322b may comprise a second bottle 322b. The first bottle 322a may have a first bottle finish (not shown) and the second bottle 322b may have a second bottle finish (not shown). The drink-enhancer system 320 has a first closure 336 and a second closure 338. The first and second closures 336, 338 may be connected to the first and second bottle finishes, respectively, in any conventional manner (e.g., a snap connection). The first closure 336 may further comprise a first lid 336a and the second closure 338 may further comprise a second lid 338a. The first and second lids 336a, 338a may each be moveable between an open and a closed configuration via a living hinge.

The first bottle 322a is fixedly secured to the second bottle via shrink wrap 346. The shrink wrap 346 is adapted and configured to maintain the fixed securement of the first bottle 322a to the second bottle 322b during discharge of the first drink-enhancer 324a from the first chamber 326 and during discharge of the second drink-enhancer 324b from the second chamber 328. The shrink wrap 346 may comprise polyethylene terephthalate glycol (PETG) or any other suitable shrink wrap material.

The shrink wrap 346 may have a first line of weakness 348a generally adjacent the first closure 336 and a second line of weakness 348b generally adjacent the second closure 338. The first and second lines of weakness 348a, 348b The first line of weakness 348a enables a user to remove a first shrink wrap portion 350a of the shrink wrap 346 adjacent the first closure 336 while maintaining the fixed securement of the first bottle 322a to the second bottle 322b. The second line of weakness 348b enables a user to remove a second shrink wrap portion 350b of the shrink wrap 346 adjacent the second closure 338 while maintaining the fixed securement of the first bottle 322a to the second bottle 322b. The first line of weakness 348a may comprise a score line 348a. Likewise, the second line of weakness 348b may comprise a score line 348b.

For example, the shrink wrap 346 may initially cover the first and second bottles, including the first and second closures along with their respective lids. The first shrink wrap portion 350a may be removed to expose the first lid 336a and at least a portion of the first closure 336. Likewise, the second shrink wrap portion 350b may be removed to expose the second lid 338a and at least a portion of the second closure 338. Preferably, the respective score lines are positioned such that, after the first and second shrink wrap portions 350a, 350b are removed, the shrink wrap still covers at least a portion of the first and second closures 336, 338 while allowing the lids 336a, 338a to be moved between the open and closed configurations.

The first bottle 322a may further comprise a base end 352a opposite the first discharge opening 332 and the second bottle 322b may further comprise a base end 352b opposite the second discharge opening 334. The first bottle 322a may be fixedly secured to the second bottle 322b via the shrink wrap 346 such that the base ends 352a, 352b of the first and second bottles are face-to-face and immediately adjacent one another.

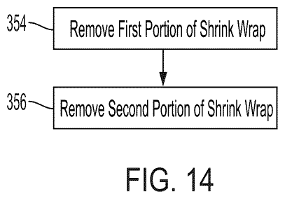

A method of using the drink enhancer of the present embodiment is disclosed in FIG. 14. The first shrink wrap portion 350a of the shrink wrap 346 is removed via the first score line 348a (see element 354). The second shrink wrap portion 350b of the shrink wrap 346 is removed via the second score line 348b (see element 356). The first and second shrink wrap portions 350a, 350b are removed in a manner such that the fixed securement of the first bottle 322a to the second bottle 322b by the shrink wrap 346 is maintained.

In view of the foregoing, it should be appreciated that the invention has several advantages over the prior art.

It should also be understood that when introducing elements of the present invention in the claims or in the above description of exemplary embodiments of the invention, the terms “comprising,” “including,” and “having” are intended to be open-ended and mean that there may be additional elements other than the listed elements. Additionally, the term “portion” should be construed as meaning some or all of the item or element that it qualifies. Moreover, use of identifiers such as first, second, and third should not be construed in a manner imposing any relative position or time sequence between limitations.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

1. A drink-enhancer system comprising:
a container apparatus comprising a first chamber, a second chamber, and a barrier to prevent liquid within one of the first and second chambers to flow to the other of the first and second chambers;
a plurality of drink-enhancers comprising at least a first drink-enhancer and a second drink-enhancer, each of the first and second drink-enhancers being liquid, the second drink-enhancer being different from the first drink-enhancer, the first drink-enhancer being in the first chamber of the container apparatus, the second drink-enhancer being in the second chamber of the container apparatus, wherein the contents of the first chamber are different from the contents of the second chamber;
a first discharge opening and a second discharge opening, the first discharge opening being adapted and configured to discharge the first drink-enhancer from the first chamber, the second discharge opening being adapted and configured to discharge the second drink-enhancer from the second chamber, the container apparatus further comprising at least one closure;
a first outlet valve in fluid communication with the first discharge opening, a second outlet valve in fluid communication with the second discharge opening, each of the first and second valves being movable between a closed position and an open position, each of the first and second valves being biased towards the closed position, the first valve being movable from its closed position to its open position upon an increase of fluid pressure in the first chamber, the second valve being movable from its closed position to its open position upon an increase of fluid pressure in the second chamber;
wherein the at least one closure comprises a first closure, and wherein the drink-enhancer system further comprises a second closure, the first closure being adapted and configured to removably cover the first discharge opening, the second closure being adapted and configured to removably cover the second discharge opening, the first closure and the second closure being independently operable;
wherein the container apparatus comprises a first member and a second member, the first member being a unitary, one-piece molded member, the second member being a unitary, one-piece molded member, the first chamber being within and defined by the first member, the second chamber being within and defined by the second member, the first member being fixedly secured to the second member;
wherein the first member comprises a first bottle and the second member comprises a second bottle, the first bottle being fixedly secured to the second bottle via shrink wrap, the shrink wrap being adapted and configured to maintain the fixed securement of the first bottle to the second bottle during discharge of the first drink-enhancer from the first chamber and during discharge of the second drink-enhancer from the second chamber;
wherein the shrink wrap has a first line of weakness adjacent the first closure and a second line of weakness adjacent the second closure, the first line of weakness enabling a user to remove a first shrink wrap portion of the shrink wrap adjacent the first closure while maintaining the fixed securement of the first bottle to the second bottle, the second line of weakness enabling a user to remove a second shrink wrap portion of the shrink wrap adjacent the second closure while maintaining the fixed securement of the first bottle to the second bottle;
wherein the first bottle further comprises a base end opposite the first discharge opening and the second bottle further comprises a base end opposite the second discharge opening, the first bottle being fixedly secured to the second bottle via the shrink wrap such that the base ends of the first and second bottles are face-to-face and immediately adjacent one another.

2. (canceled)

3. (canceled)

4. (canceled)

5. (canceled)

6. (canceled)

7. The drink-enhancer system of claim 1 wherein the first line of weakness comprises a score line and the second line of weakness comprises a score line.

8. A method of using the drink-enhancer system of claim 7 comprising:
removing the first shrink wrap portion of the shrink wrap via the first score line;
removing the second shrink wrap portion of the shrink wrap via the second score line; and
wherein the first and second shrink wrap portions of the shrink wrap are removed in a manner such that the fixed securement of the first bottle to the second bottle by the shrink wrap is maintained.

9. (canceled)

10. The drink-enhancer system of claim 1 wherein the container apparatus comprises a single bottle, the first and second chambers being chambers of the single bottle.

11. (canceled)

12. (canceled)

13. (canceled)

14. (canceled)

15. The drink-enhancer system of claim 1, wherein the first drink-enhancer comprises at least one flavor component, one or more alcohol based solvent components, and one or more acids.

16. The drink-enhancer system of claim 15, wherein the first drink-enhancer further comprises a fruit juice concentrate.

17. The drink-enhancer system of claim 1, wherein the first drink-enhancer comprises at least an acid and the second drink-enhancer comprises at least a sweetener.

18. The drink-enhancer system of claim 1, wherein the first drink-enhancer comprises one or more of a caffeine, electrolyte, vitamin, mineral, probiotic, prebiotic, protein, fatty acid, fiber, carbohydrate, oil, grain, amino acid, juice concentrate, fruit extract, vegetable extract, herbal extract, phytochemical, or antioxidant.

19. The drink-enhancer system of claim 18, wherein the second drink-enhancer comprises one or more of a caffeine, electrolyte, vitamin, mineral, probiotic, prebiotic, protein, fatty acid, fiber, carbohydrate, oil, grain, amino acid, juice concentrate, fruit extract, vegetable extract, herbal extract, phytochemical, or antioxidant.

20. The drink-enhancer system of claim 1, wherein the first outlet valve comprises a flow-control valve in fluid communication with the first chamber, the flow-control valve being adapted and configured to dispense a specific dosage of the first drink-enhancer.

21. (canceled)

22. (canceled)

23. (canceled)

24. (canceled)

25. The drink-enhancer system of claim 1 wherein at least the first drink enhancer may be added to a drink, and wherein the drink comprises one or more of water, sparkling water, ice, dairy milk, plant-based milk, hard liquor, beer, wine, carbonated beverage, fermented beverage, sports drink, energy drink, juice, tea, and coffee.

26. The drink-enhancer system of claim 25 wherein the first drink-enhancer comprises one or more of a caffeine, electrolyte, vitamin, mineral, probiotic, prebiotic, protein, fatty acid, fiber, carbohydrate, oil, grain, amino acid, juice concentrate, fruit extract, vegetable extract, herbal extract, phytochemical, or antioxidant.
